(19) United States
(12) Patent Application Publication
(10) Pub. No.: US 2013/0116922 A1
(43) Pub. Date: May 9, 2013

(54) EMERGENCY GUIDING SYSTEM, SERVER AND PORTABLE DEVICE USING AUGMENTED REALITY

(71) Applicants: YI-WEN CAI, Tu-Cheng (TW); SHIH-CHENG WANG, Tu-Cheng (TW)

(72) Inventors: YI-WEN CAI, Tu-Cheng (TW); SHIH-CHENG WANG, Tu-Cheng (TW)

(73) Assignee: HON HAI PRECISION INDUSTRY CO., LTD., Tu-Cheng (TW)

(21) Appl. No.: 13/291,199

(22) Filed: Nov. 8, 2011

(51) Int. Cl. G01C 21/00; G09G 5/00

(52) U.S. Cl. 701/515; 345/633

(57) ABSTRACT

An emergency guiding system is provided. The emergency guiding system includes an emergency guiding server and a portable device. The emergency guiding server includes a guiding scheme determination unit producing a guiding scheme and an augmented reality information unit. The portable device transmits an image characteristic signal including image data produced according to an image to the emergency guiding server. The emergency guiding server transmits an augmented reality signal to the portable device, wherein the augmented reality signal includes an augmented reality data produced by the augmented reality information unit according to the guiding scheme, the image data, and a portable device location information in a location signal corresponding to the portable device. The portable device produces an augmented reality image according to the image and the augmented reality data. The disclosure further provides an emergency guiding server and an emergency guiding portable device.

### BACKGROUND

1. Technical Field

The present disclosure relates to an emergency guiding system and an emergency guiding server, and particularly to an emergency guiding system and an emergency guiding server using augmented reality.

2. Description of Related Art

In a conventional emergency guiding system, evacuation guidance is provided through devices often immovably disposed along the evacuation pathway. When in an emergency, evacuation guidance is provided through the devices such as indicator lights or speakers. However, restricted by the hardware or the software conditions, the devices can only provide simple guidance such as evacuating direction. Hence, the evacuation could be affected when a person unfamiliar with the operation of related devices such as emergency exit. In addition, when there is no viable evacuation route, the traditional devices are not capable of providing suitable refuge guidance.

What is needed, therefore, is an emergency guiding system capable of overcoming the limitation described.

### BRIEF DESCRIPTION OF THE DRAWINGS

Many aspects of the present disclosure can be better understood with reference to the following drawing(s). The components in the drawing(s) are not necessarily drawn to scale, the emphasis instead being placed upon clearly illustrating the principles of the present disclosure. Moreover, in the drawing(s), like reference numerals designate corresponding parts throughout the several views.

FIG. 1 is a block diagram of an embodiment of an emergency guiding system of the present disclosure.

FIG. 2A is a block diagram of another embodiment of an emergency guiding system of the present disclosure.

FIG. 2B is a schematic view of an embodiment of the layout of the short distance wireless identifiers of the emergency guiding system of FIG. 2A on a floor plan.

FIG. 3A is a schematic view of an embodiment using the emergency guiding system of FIG. 1.

FIG. 3B is a schematic view of an embodiment displaying an indicating message in an augmented reality mode of the portable device of the emergency guiding system of FIG. 1.

FIG. 3C is a schematic view of an embodiment displaying a warning message in the augmented reality mode of the portable device of the emergency guiding system of FIG. 1.

FIGS. 3D, 3E, and 3F are schematic views of an embodiment displaying a route chart in a route chart mode of the portable device of the emergency guiding system of FIG. 1.

FIG. 4A is a schematic view of another embodiment using the emergency guiding system of FIG. 1.

FIG. 4B is a schematic view of an embodiment displaying a directing diagram in the augmented reality mode of the portable device of the emergency guiding system of FIG. 4A.

FIG. 5 is a schematic view of the other embodiment using the emergency guiding system of FIG. 1.

### DETAILED DESCRIPTION

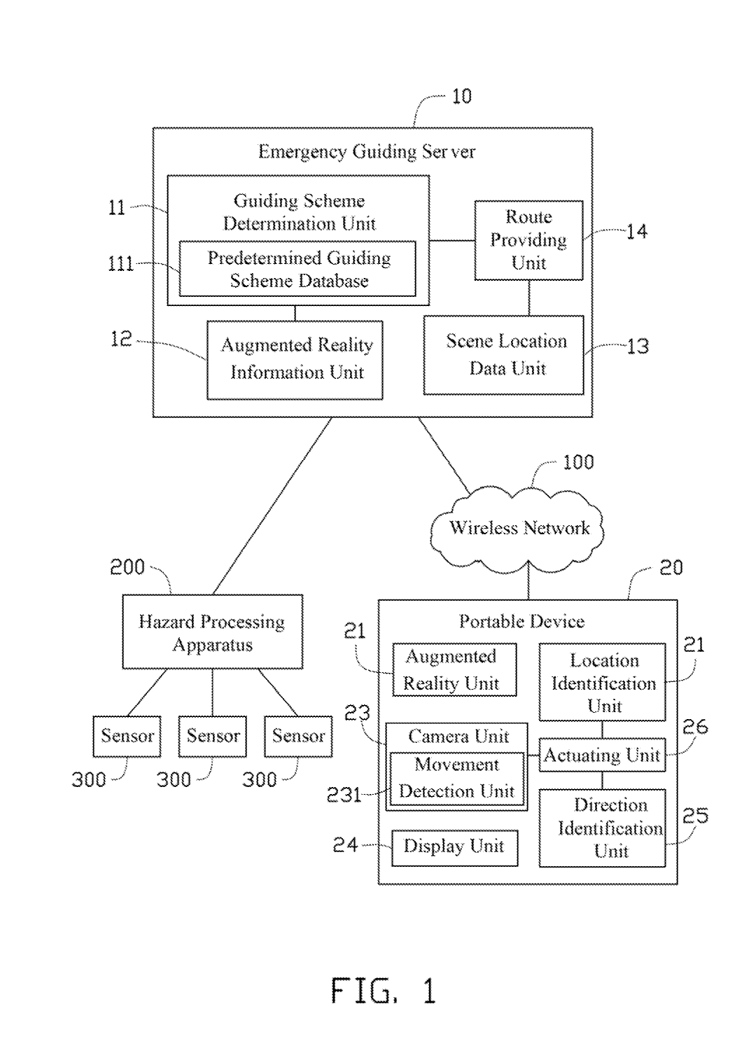

FIG. 1 is a block diagram of an embodiment of an emergency guiding system of the present disclosure. As shown in FIG. 1, an emergency guiding system includes an emergency guiding server 10 and a portable device 20. In the illustrated embodiment, the emergency guiding system is applied in response to a fire emergency. In other embodiments, the emergency guiding system can be applied to other types of emergencies such as an earthquake, illegal entry, or other potentially hazardous situations. The emergency guiding server 10 communicates with the portable device 20 through a wireless network 100. The wireless network 100 is implemented according to a telecommunication standard such as Wi-Fi, Bluetooth, and GSM (Global System for Mobile Communications).

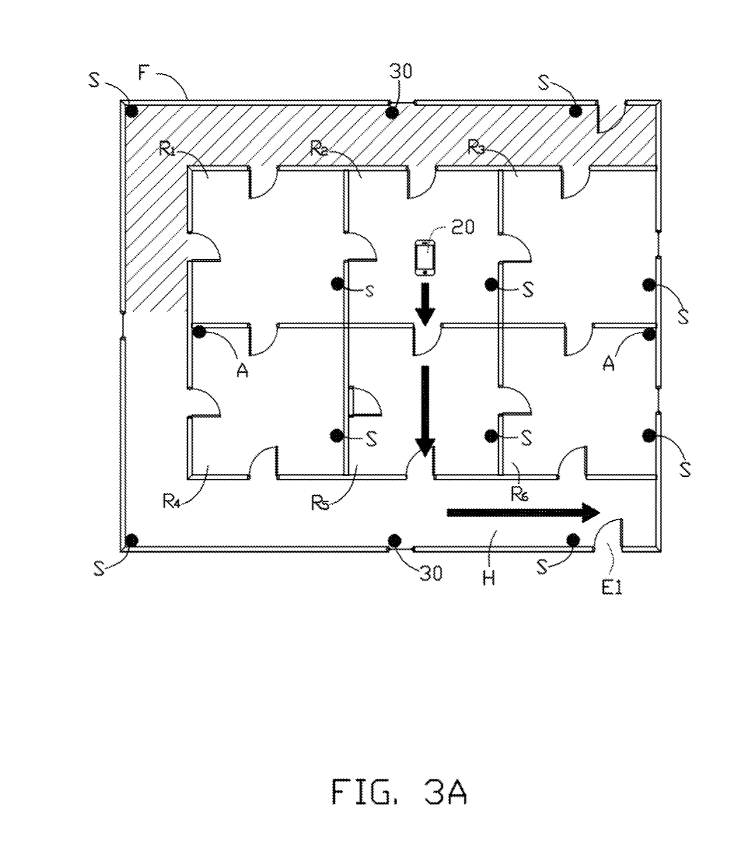

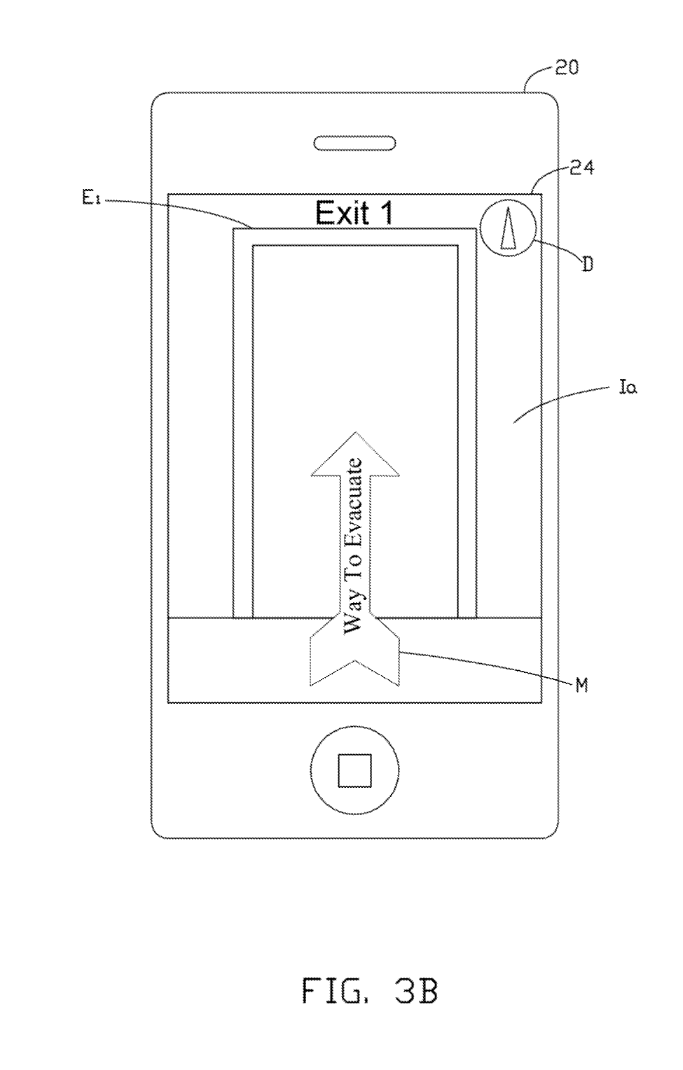

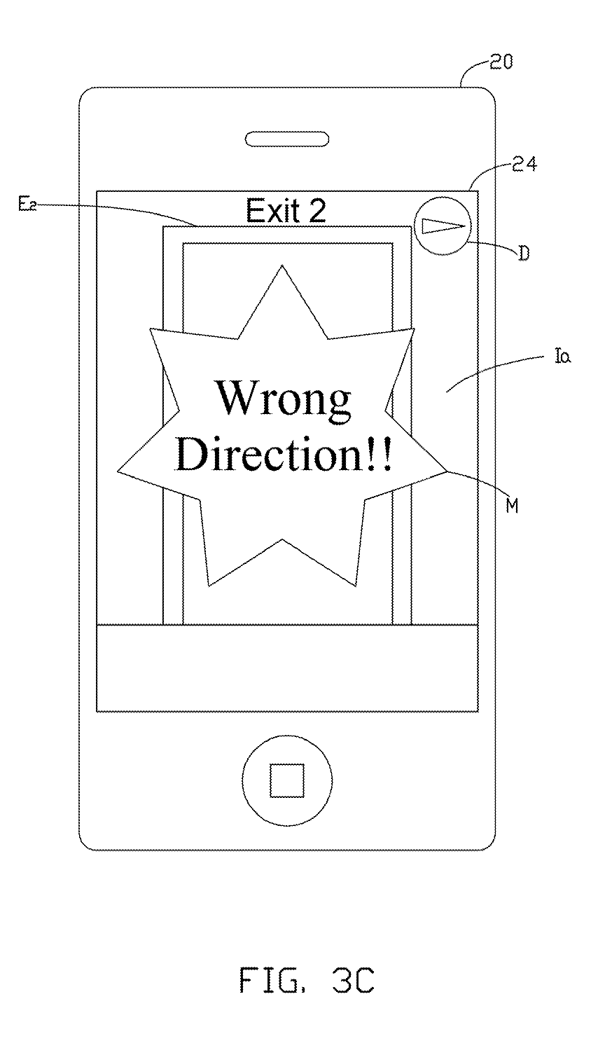

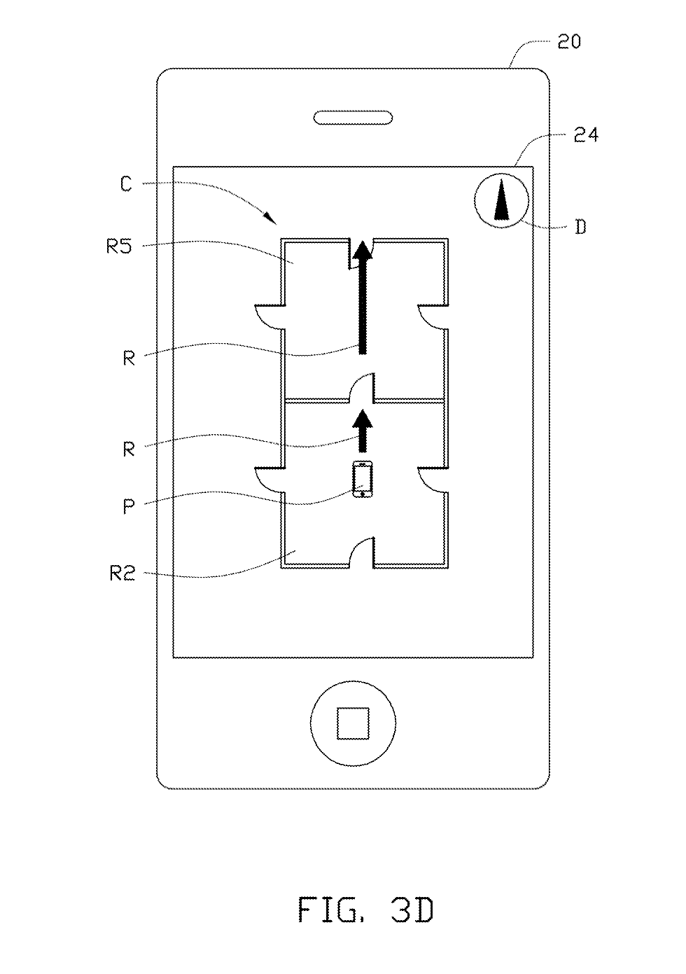

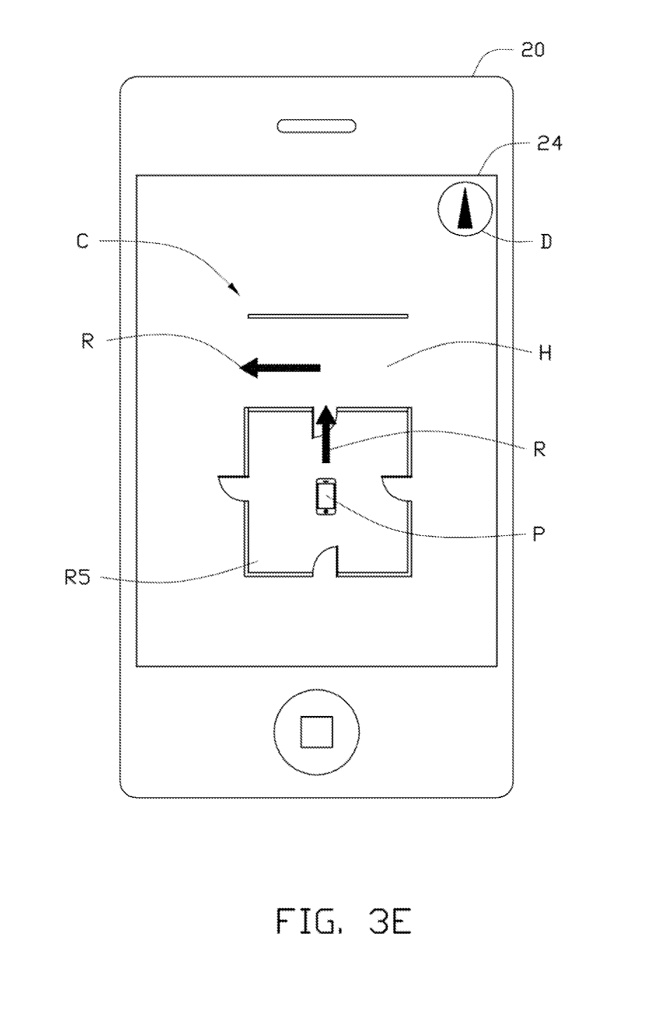

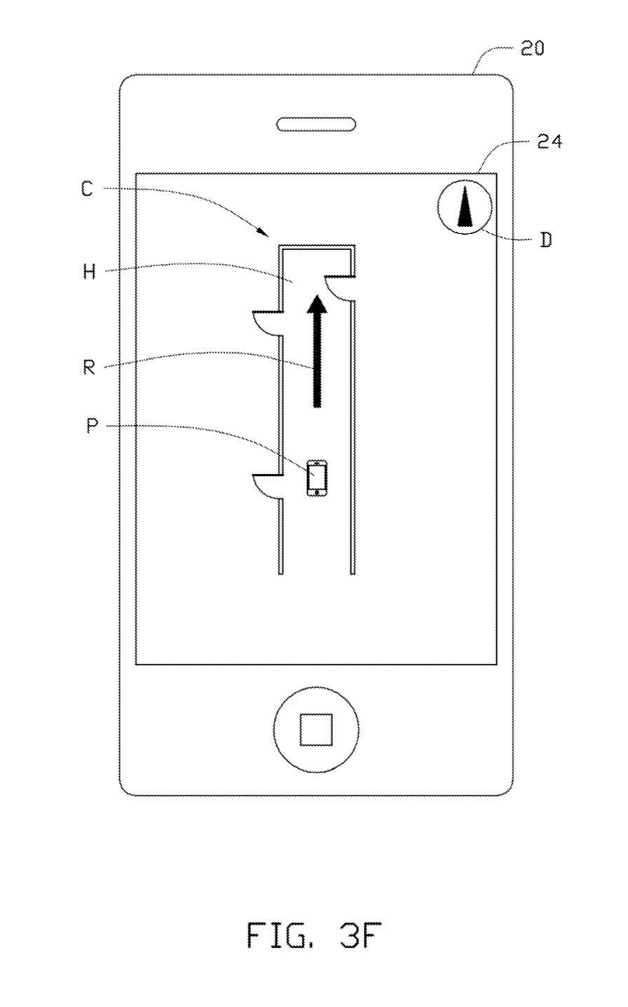

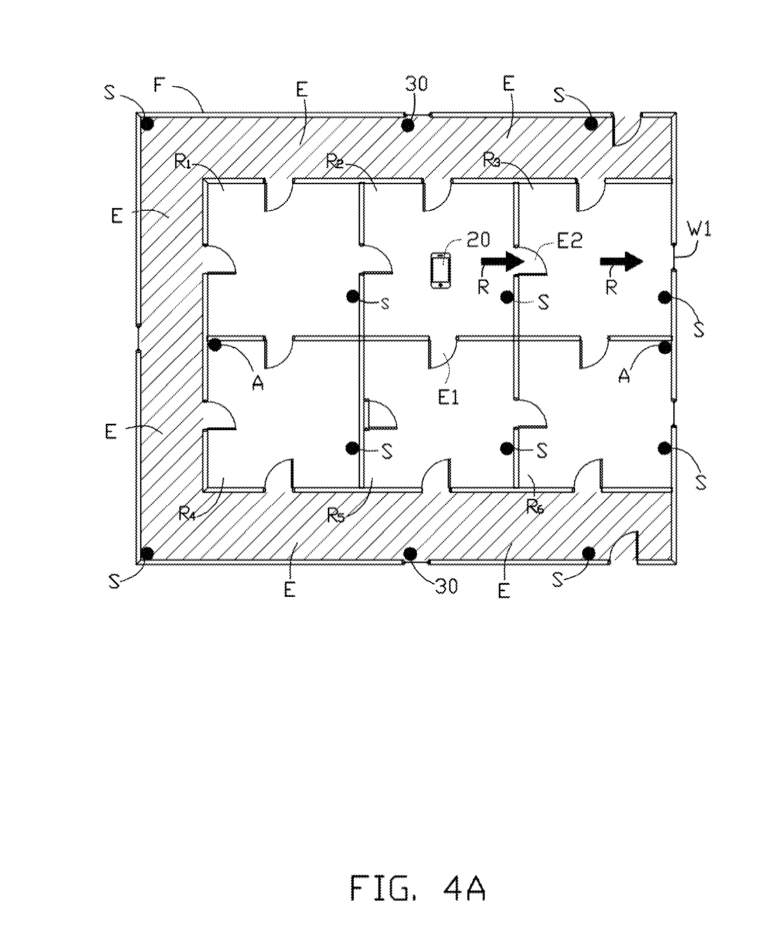

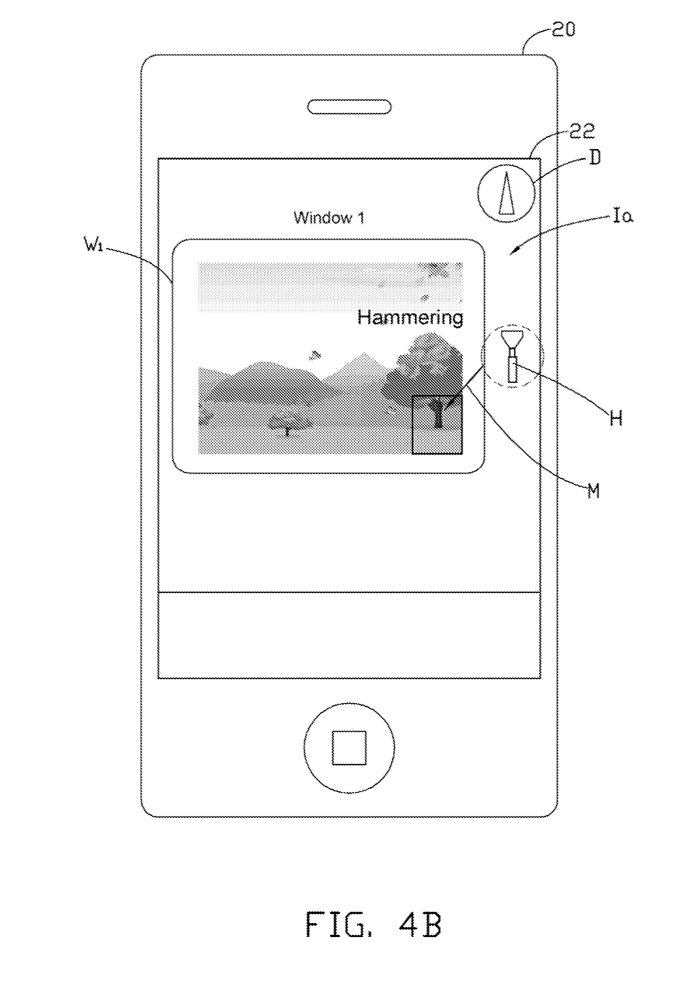

The emergency guiding server 10 includes a guiding scheme determination unit 11, an augmented reality information unit 12, a scene location data unit 13, and a route providing unit 14. The guiding scheme determination unit 11 produces a guiding scheme G (not shown) in response to the current status of an emergency area E of an emergency (see FIG. 3A) such as a fire hazard or an illegal entry in real time. The augmented reality information unit 12 produces an augmented reality data Dₐ (not shown) including a prompt message M (see FIGS. 3B, 3C, and 4B), according to the guiding scheme G, image data Dᵢ in an image characteristic signal S_{c} (not shown) received from the portable device 20, and a portable device location information Iₚ in a location signal S₁ corresponding to the portable device 20, in response to the production of the last guiding scheme G when the device location information I_{d} in the location signal Sᵢ matches one set of scene location information I₁ in the scene location data unit 13, and then the emergency guiding server 10 transmits an augmented reality signal Sₐ (not shown) including the augmented reality data Dₐ to the portable device 20. The prompt message M is for informing the user of the portable device 20 about the information of the image corresponding to the image data Dᵢ, thereby directing the user of the portable device 20 to perform actions such as moving in a particular direction or operating a device in a particular step. The scene location data unit 13 includes a plurality of sets of scene location information I₁ (now shown) each corresponds to one individual scene such as a room, a hallway, a floor plan, a carriage of a vehicle, a cabin of a ship, or other types of spaces. In the illustrated embodiment, the scene location data unit 13 is a database which capable of inputting, storing, and outputting the scene location information I₁, while each set of scene location information I₁ includes a range of latitudes, longitudes, and elevations of individual scene which are for identifying the scope of the scene. In other embodiments, the scene location data unit 13 can be other types of data structure, while each set of scene location information I₁ can include a range of other types of location related parameters of individual scene. The emergency guiding server 10 receives a location signal S₁ (not shown) from the portable device 20, wherein the location signal S₁ includes device location information I_{d} of the portable device 20. The route providing unit 14 produces a recommended route R (see FIG. 3A) to reach a particular target such as an exit, a secure area, or a fire fighting apparatus in response to the production of the last guiding scheme. The recommended route R is produced according to the last guiding scheme G and the device location information I_{d} in the location signal S₁ when the device location information I_{d} in the location signal S₁ matches one set of scene location information I₁ in the scene location data unit 13, and then the emergency guiding server 10 transmits a guiding signal S_{g} (not shown) including the recommended route R to the portable device 20. In other embodiments, the emergency guiding server 10 transmit a portion of the recommended route R, the portion being the part of the recommended route R adjacent to the portable device 20, while the range of the recommended route R (including the boundary and the detail of the recommended route R) transmitted to the portable device 20 is adjusted according to a route range signal Sᵣ (not shown) received from the portable device 20.

In the illustrated embodiment, the emergency guiding server 10 is alerted to the emergency in the emergency area E by an alarm signal Sₐ (not shown) received from a hazard processing apparatus 200 which is coupled to a plurality of sensors 300. The hazard processing apparatus 200 is a fire alarm control panel. The hazard processing apparatus 200 transmits the alarm signal Sₐ including status information Iₛ (not shown) of the actuated sensors 300 to the emergency guiding server 10 when the emergency in the emergency area E is detected by the sensors 300. The guiding scheme determination unit 11 includes a predetermined guiding scheme database 111 including predetermined guiding schemes Gₚ (not shown) corresponding to the sensors 300. The predetermined guiding schemes Gₚ are guiding schemes determined in advance according to various possible scenarios of the kind of sensory data that might be received from the sensors 300 such as the location, the type, the detected parameters, and the actuation time of the sensors 300. Each of the predetermined guiding schemes Gₚ includes various sets of the status of the sensors 300 which are conditions in choosing the schemes, the prompt message M, and the recommended route R. In other embodiments, the predetermined guiding schemes Gₚ can include the location of other objects related to the emergency such as fire fighting apparatus. The guiding scheme determination unit 11 chooses one of the predetermined guiding schemes Gₚ as the guiding scheme G according to the status information Iₛ of the actuated sensors 300 in the alarm signal Sₐ. In other embodiments, the guiding scheme determination unit 11 can determine the guiding scheme G by other methods such as using a guiding scheme determination algorithm, instead of using the predetermined guiding scheme database 111. In addition, the emergency guiding server 10 can receive the alarm signal Sₐ directly from the sensors 300. Since the emergency guiding server 10 is alerted to the emergency by the alarm signal Sₐ which represents the real time conditions of the emergency in the emergency area E, the recommended route R can be produced in a dynamic manner and updated correspondingly.

The portable device 20 includes a location identification unit 21, an augmented reality unit 22, a camera unit 23, a display unit 24, a direction identification unit 25, and an actuating unit 26. In the illustrated embodiment, the portable device 20 is a smart phone. In other embodiments, the portable device 20 can be other types of portable electronic devices such as mobile phones, tablet computers, or notebook computers, and a portion of the an augmented reality information unit 12 of the emergency guiding server 10 can be implemented in the portable device 20. The portable device 20 produces the image characteristic signal S_{c} (not shown) corresponding to an image Iᵣ (not shown) captured by the camera unit 23, and transmits the image characteristic signal S_{c} to the emergency guiding server 10. The image characteristic signal S_{c} includes the image data Dᵢ (not shown) of the image Iᵣ. In the illustrated embodiment, the location identification unit 21 is a GPS (Global Positioning System) receiver which produces the device location information I_{d} including a latitude, a longitude, and an elevation of the portable device 20. In other embodiments, the location identification unit 21 can be other types of devices such as WPS (Wi-Fi Positioning System) receiver, while the device location information I_{d} can include other types of location related parameters of the portable device 20. The augmented reality unit 22 produces an augmented reality image Iₐ. (see FIG. 6) according to the image Iₐ and the augmented reality data Dₐ in the augmented reality signal Sₐ. In the illustrated embodiment, the camera unit 23 includes an accelerometer 231 to determine an angle of the image Iᵣ, and the image data Dᵢ include the pixels and the angle of the image Iᵣ. In other embodiments, the camera unit 23 can include other devices such as GPS device and electronic compass, and the image data Dᵢ can include other data relate to the image Iᵣ such as location and direction which are necessary for augmented reality.

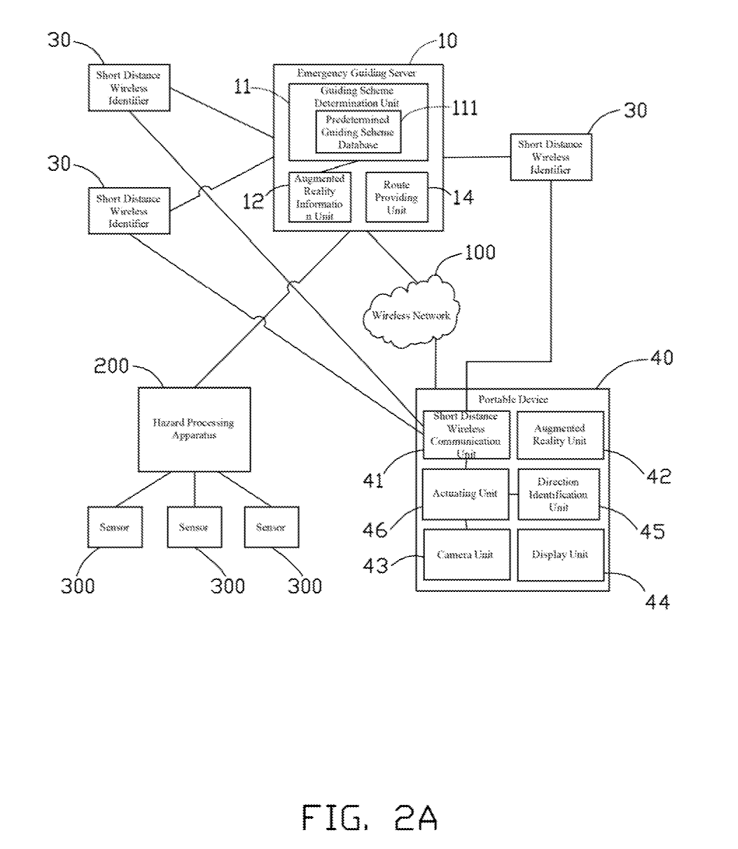

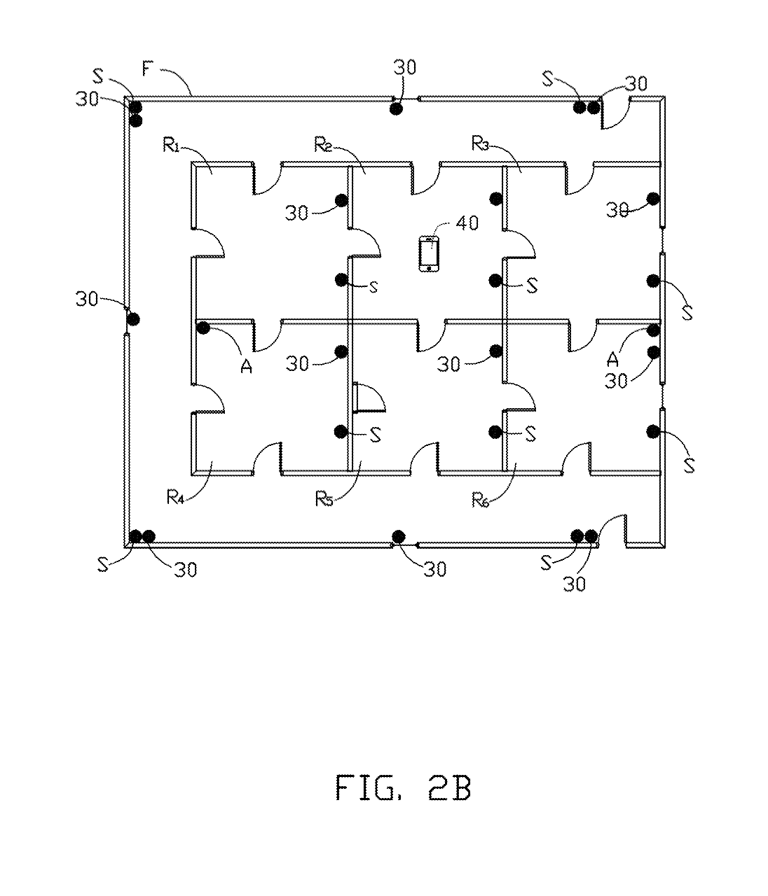

In other embodiments, the emergency guiding server 10 can determine the location of the portable device 20 through other devices instead of the location identification unit 21. FIG. 2A is a block diagram of another embodiment of an emergency guiding system of the present disclosure. As shown in FIG. 2A, in comparison with the embodiment of FIG. 1, the emergency guiding system further includes short distance wireless identifiers 30; the emergency guiding server 10 does not include the scene location data unit 13; the portable device 40 includes a short distance wireless communication unit 41, an augmented reality unit 42, a camera unit 43, a display unit 44, a direction identification unit 45, and an actuating unit 46. The augmented reality unit 42, the camera unit 43, the display unit 44, the direction identification unit 45, and the actuating unit 46 are as the augmented reality unit 22, the camera unit 23, the display unit 24, the direction identification unit 25, and the actuating unit 26 of the portable device 20, respectively. The short distance wireless identifiers 30 communicate with the portable device 40 through the short distance wireless communication unit 41, thereby detecting the presence of the portable device 40 and transmitting the corresponding location signal S₁ to the emergency guiding server 10. In the illustrated embodiment, the location signal S₁ includes a location of the portable device 40. In other embodiments, the location signal S₁ can include a location of the short distance wireless identifier 30, or other parameters of the portable device 40 and the short distance wireless identifier 30. In addition, the location of the portable device 40 can be determined through the location signals S₁ received from a plurality of the short distance wireless identifiers 30. In the illustrated embodiment, the short distance wireless communication unit 41 is a Bluetooth transmitter. Correspondingly, the short distance wireless identifiers 30 are Bluetooth receivers. In other embodiments, the short distance wireless communication unit 41 and the short distance wireless identifiers 30 can be other types of devices implemented according to other types of telecommunication standards. For example, the short distance wireless communication unit 41 and the short distance wireless identifiers 30 can be an RFID (radio-frequency identification) tag and RFID readers, respectively. In addition, the short distance wireless communication unit 41 and the short distance wireless identifiers 30 can be a transmitter and receivers of near field communication (NFC), respectively. FIG. 2B is a schematic view of an embodiment of the layout of the short distance wireless identifiers of the emergency guiding system of FIG. 2A on a floor plan. As shown in FIG. 2B, in the illustrated embodiment, the short distance wireless identifiers 30 are distributed over a floor plan F such that the portable device 40 shown as a portable device icon P can be detected at any corner of the floor plan F, wherein the floor plan F including rooms R₁ to R₆ is a scene of the emergency. In other embodiments, the short distance wireless identifiers 30 can be disposed in other types of spaces such as a room, a hallway, a carriage of a vehicle, or a cabin of a ship, and can be disposed in other manners so as to correspond to actual demands.

FIG. 3A is a schematic view of an embodiment using the emergency guiding system of FIG. 1. As shown in FIG. 3A, the sensors 300 shown as sensor icons S are disposed on the floor plan F. The scope with respect to the emergency, which is detected by the sensors 300, is marked as the emergency area E. The recommended route R to an exit leading into the exterior is shown as arrows. FIG. 3B is a schematic view of an embodiment displaying an indicating message in an augmented reality mode of the portable device of the emergency guiding system of FIG. 1. As shown in FIG. 3B, in the augmented reality mode, the display unit 24 of the portable device 20 displays the augmented reality image Iₐ including the prompt message M shown as an indicating message to indicate a direction to evacuate (that is, the direction toward an exit E₁, see also FIG. 3A). In addition, the display unit 24 further displays an indicator D to indicate the direction to evacuate according to the prompt message M. FIG. 3C is a schematic view of an embodiment displaying a warning message in the augmented reality mode of the portable device of the emergency guiding system of FIG. 1. As shown in FIG. 3C, the display unit 24 of the portable device 20 displays the augmented reality image Iₐ including the prompt message M shown as a warning message when the direction which the portable device 20 moves (that is, the direction toward an exit E₂, see also FIG. 3A) not corresponds to the guiding scheme G.

FIGS. 3D, 3E, and 3F are schematic views of an embodiment displaying a route chart in a route chart mode of the portable device of the emergency guiding system of FIG. 1. As shown in FIG. 3D, in the route chart mode, the display unit 24 displays a route chart C including a portion of the recommended route R adjacent to the portable device 20 and the portable device icon P representing the location and the direction of the portable device 20, wherein the route chart C is produced according to the recommended route R in the guiding signal S_{g}. In other embodiments, the route chart C can be produced by the route providing unit 14 of the emergency guiding server 10, while the guiding signal S_{g} includes the route chart C instead of merely including the recommended route R. The range of the recommended route R displayed by the display unit 24 can be adjusted according to actual demands by, for instance, finger translation gestures with respect to the route chart C displayed on the display unit 24. The direction identification unit 25 determines a direction of the portable device 20. The direction identification unit 25 is a device such as electronic compass and magnetometer which is capable of determining Earth's magnetic field. In this embodiment, the route chart C displayed by the display unit 24 includes a portion of the recommended route R which is one unit of space adjacent to the portable device 20. Since the portable device 20 shown as the portable device icon P is in the room R₂, the route chart C includes a portion of the recommended route R which is in the room R₂ and the room R₅ adjacent to the room R₂. As shown in FIG. 3E, since the portable device icon P is in the room R₅, the route chart C includes a portion of the recommended route R which is in the room R₅ and a hallway H adjacent to the room R₅. As shown in FIG. 3F, since the portable device icon P is in the hallway H, the route chart C includes a portion of the recommended route R which is in the hallway H. In other embodiments, the direction of the route chart can be fixed to a particular direction corresponding to the scene of the emergency. As shown in FIGS. 3D, 3E, and 3F, in the illustrated embodiment, the route chart C automatically rotates corresponding to the direction of the portable device 20, such that the direction to evacuate corresponds to the top side of the display unit 24.

In the illustrated embodiment, the actuating unit 26 such as an application software automatically enables the location identification unit 21 and the direction identification unit 25 in response to a triggering signal Sₜ (not shown) received from the emergency guiding server 10, and then directs the portable device 20 to transmit the location signal S₁ to the emergency guiding server 10, wherein the emergency guiding server 10 produces the triggering signal Sₜ in response to the emergency. In other embodiments, the actuating unit 26 can automatically enable/disable other components of the portable device 20 which are necessary for the operation of the emergency guiding system. For example, in the embodiment of FIG. 2A, the actuating unit 46 enables the short distance wireless communication unit 41 and the direction identification unit 25. In addition, the portable device 20 can include a speaker unit such as phone speaker or loudspeaker, thereby providing audio guidance according to the recommended route R in the guiding signal S_{g} or the prompt message M in the augmented reality data Dₐ. The audio guidance can be provided through, for example, a phone call to drive the speaker unit.

FIG. 4A is a schematic view of another embodiment using the emergency guiding system of FIG. 1. As shown in FIG. 4A, the recommended route R to a window W₁ leading into the exterior is shown as arrows while all exits of the floor plan F which are leading into the exterior are not accessible. In the illustrated embodiment, the recommended route R is to reach particular targets including a window W₁ and a hammer H (see FIG. 4B), and the augmented reality data Dₐ includes the prompt message M for the window W₁ and the hammer H. FIG. 4B is a schematic view of an embodiment displaying a directing diagram in the augmented reality mode of the portable device of the emergency guiding system of FIG. 4A. As shown in FIG. 4B, the display unit 24 of the portable device 20 displays the augmented reality image Iₐ including the prompt message M shown as a directing diagram. In the illustrated embodiment, the prompt message M directs the user of the portable device 20 to use a hammer H to hammer a corner of the window W₁, thereby breaking the glass of the window W₁ such that the window W₁ can be used as an exit to evacuate.

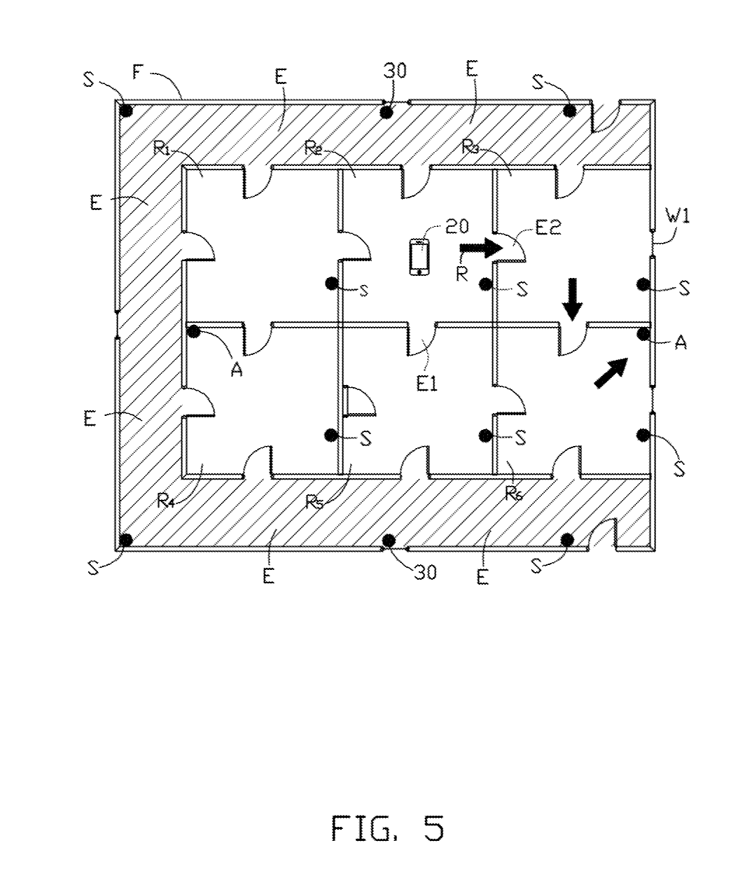

In other embodiments, the prompt message M can direct the user of the portable device 20 to perform other types of actions. FIG. 5 is a schematic view of the other embodiment using the emergency guiding system of FIG. 1. As shown in FIG. 5, the recommended route R is to reach a fire fighting apparatus A, while the augmented reality data Dₐ includes the prompt message M for directing the user of the portable device 20 to operate the fire fighting apparatus A by certain steps. The location of fire fighting apparatuses A and other objects related to the emergency such as combustibles have to keep an eye on can be stored in the guiding scheme determination unit 11 to be a portion of the predetermined guiding schemes Gₚ.

In the illustrated embodiment, the portable device 20 is automatically switched to the augmented reality mode when approaching a particular target and the particular target is capable of being recognized through the camera unit 23, thereby displaying the augmented reality image Iₐ as shown in FIGS. 3B, 3C, and 4B; otherwise, the portable device is automatically switched to a route chart mode, thereby displaying the route chart C as shown in FIGS. 3D, 3E, and 3F. The augmented reality mode and the route chart mode can also be switched manually. In other embodiments, the portable device 20 can include a leveling unit to determine an angle between the portable device 20 and the horizon. The portable device 20 is automatically switched to the route chart mode when the portable device 20 has a particular angle with respect to the horizon, for instance, when the angle between the portable device and the horizon is smaller than 45 degrees; otherwise, the portable device is automatically switched to operate in the augmented reality mode.

The emergency guiding system utilizes a portable device to provide evacuation guidance according to the location of the portable device, and utilizes augmented reality technique to display augmented reality images. In comparison with conventional emergency guiding systems which utilize devices immovably disposed at the scene of emergency to provide evacuation guidance, the guidance is provided through a more visual way, and the effect of the emergency guiding system is therefore enhanced. In addition, since evacuation guidance are provided according to the location of the portable device and the real time condition of the emergency, the emergency guiding system is capable of providing real time and more accurate evacuation guidance to the user of the portable device. Consequently, the emergency guiding system is capable of providing sufficient and suitable guidance in response to various conditions. The emergency guiding system is especially suitable for larger scenes such as skyscrapers or factory buildings.

While the disclosure has been described by way of example and in terms of preferred embodiment, it is to be understood that the disclosure is not limited thereto. To the contrary, it is intended to cover various modifications and similar arrangements as would be apparent to those skilled in the art. Therefore, the range of the appended claims should be accorded the broadest interpretation so as to encompass all such modifications and similar arrangements.

What is claimed is:

1. An emergency guiding system, comprising:
an emergency guiding server including a guiding scheme determination unit and an augmented reality information unit, wherein the guiding scheme determination unit produces a guiding scheme according to the current status of an emergency; and
a portable device including an augmented reality unit and a camera unit, wherein the camera unit produces image data according to at least an image captured by the camera unit, the portable device transmits an image characteristic signal including the image data to the emergency guiding server;
wherein the augmented reality information unit of the emergency guiding server produces an augmented reality data according to the last guiding scheme, the image data in the image characteristic signal, and a portable device location information in a location signal corresponding to the portable device in response to the production of the guiding scheme, the emergency guiding server transmits an augmented reality signal including the augmented reality data to the portable device, the augmented reality unit of the portable device produces an augmented reality image according to the image and the augmented reality data in the augmented reality signal.

2. The system of claim 1, wherein the augmented reality data includes a prompt message.

3. The system of claim 1, wherein the emergency guiding server further includes a scene location data unit and the scene location data unit includes at least one set of scene location information, the portable device further includes a location identification unit producing the portable device location information, the portable device transmits the location signal including the portable device location information to the emergency guiding server, the augmented reality information unit of the emergency guiding server produces the augmented reality data when the portable device location information in the location signal corresponds to one set of scene location information in the scene location data unit of the emergency guiding server.

4. The system of claim 3, wherein the emergency guiding server further includes a route providing unit producing a recommended route to reach a particular target according to the guiding scheme and the location signal when the portable device location information in the location signal corresponds to one set of scene location information in the scene location data unit, the emergency guiding server transmits a guiding signal including the recommended route to the portable device.

5. The system of claim 4, wherein the portable device displays a route chart including at least a portion of the recommended route adjacent to the portable device according to the recommended route in the guiding signal.

6. The system of claim 1, further includes a plurality of short distance wireless identifiers separately disposed in scenes corresponding to the emergency, wherein the portable device further includes a short distance wireless communication unit, the short distance wireless identifiers detect the presence of the portable device through the short distance wireless communication unit, each of the short distance wireless identifiers transmits the location signal to the emergency guiding server in response to detecting the presence of the portable device.

7. The system of claim 6, wherein the emergency guiding server further includes a route providing unit producing a recommended route to reach a particular target according to the guiding scheme and the location signal, the emergency guiding server transmits a guiding signal including the recommended route to the portable device.

8. The system of claim 7, wherein the portable device displays a route chart including at least a portion of the recommended route adjacent to the portable device according to the recommended route in the guiding signal.

9. The system of claim 1, wherein the portable device is automatically switched to operate in an augmented reality mode displaying the augmented reality image when approaching a particular target, otherwise the portable device is automatically switched to operate in a route chart mode displaying a route chart including at least a portion of a recommended route adjacent to the portable device.

10. The system of claim 1, wherein the portable device further includes an actuating unit, the emergency guiding server transmits a triggering signal to the portable device to enable the actuating unit to enable the communication between the portable device and the emergency guiding server, and direct the portable device to transmit the location signal to the emergency guiding server.

11. An emergency guiding server, comprising:
a guiding scheme determination unit producing a guiding scheme according to the current status of an emergency; and
an augmented reality information unit, wherein the augmented reality information unit produces an augmented reality data in response to the production of the guiding scheme, the augmented reality data is produced according to the last guiding scheme, image data in an image characteristic signal received from a portable device, and a portable device location information in a location signal corresponding to the portable device, the emergency guiding server transmits an augmented reality signal including the augmented reality data to the portable device, wherein the image data corresponds to at least an image captured by the portable device.

12. The server of claim 11, wherein the augmented reality data includes a prompt message.

13. The server of claim 11, wherein the server further includes a scene location data unit and the scene location data unit includes at least one set of scene location information, the portable device includes a location identification unit producing the portable device location information, the portable device transmits the location signal including the portable device location information to the server, the augmented reality information unit of the server produces the augmented reality data when the portable device location information in the location signal corresponds to one set of scene location information in the scene location data unit of the server.

14. The server of claim 13, wherein the server further includes a route providing unit producing a recommended route to reach a particular target according to the guiding scheme and the location signal when the portable device location information in the location signal corresponds to one set of scene location information in the scene location data unit.

15. The server of claim 11, further includes a plurality of short distance wireless identifiers separately disposed in scenes corresponding to the emergency, wherein the portable device includes a short distance wireless communication unit, the short distance wireless identifiers detect the presence of the portable device through the short distance wireless communication unit, each of the short distance wireless identifiers transmits the location signal to the server in response to detecting the presence of the portable device.

16. The server of claim 15, wherein the server further includes a route providing unit producing a recommended route to reach a particular target according to the guiding scheme and the location signal, the server transmits a guiding signal including the recommended route to the portable device.

17. An emergency guiding portable device receiving an augmented reality signal from an emergency guiding server, the augmented reality signal including augmented reality data produced according to image data, the emergency guiding portable device comprising:
a camera unit, wherein the camera unit produces the image data according to at least an image captured by the camera unit, the emergency guiding portable device transmits an image characteristic signal including the image data to the emergency guiding server; and
an augmented reality unit, wherein the augmented reality unit produces an augmented reality image according to the image and the augmented reality data in the augmented reality signal.

18. The portable device of claim 17, wherein the portable device is automatically switched to operate in an augmented reality mode displaying the augmented reality image when approaching a particular target, otherwise the portable device is automatically switched to operate in a route chart mode displaying a route chart including at least a portion of a recommended route adjacent to the portable device.

19. The portable device of claim 17, wherein the portable device further includes a leveling unit determining an angle between the portable device and the horizon, the portable device is automatically switched to operate in a route chart mode displaying a route chart including at least a portion of a recommended route adjacent to the portable device when the angle is substantially equal to a particular angle, otherwise the portable device is automatically switched to operate in an augmented reality mode displaying the augmented reality image.

20. The portable device of claim 17, wherein the portable device further includes an actuating unit enabling the communication between the portable device and the emergency guiding server and directing the portable device to transmit the location signal to the emergency guiding server in response to a triggering signal received from the emergency guiding server.
